(19) United States
(12) Patent Application Publication
(10) Pub. No.: US 2014/0176860 A1
(43) Pub. Date: Jun. 26, 2014

(54) LIGHT GUIDE PLATE, BACKLIGHT MODULE AND LIQUID CRYSTAL DISPLAY DEVICE INCLUDING SAME

(71) Applicant: HON HAI PRECISION INDUSTRY CO., LTD., New Taipei (TW)

(72) Inventor: YUNG-CHANG TSENG, New Taipei (TW)

(73) Assignee: HON HAI PRECISION INDUSTRY CO., LTD., New Taipei (TW)

(21) Appl. No.: 13/792,163

(22) Filed: Mar. 10, 2013

(30) Foreign Application Priority Data
Dec. 26, 2012 (TW) 101150287

(51) Int. Cl. G02F 1/1335

(52) U.S. Cl. CPC G02F 1/133524
USPC 349/62; 362/622; 362/609; 362/607

(57) ABSTRACT

A backlight module includes a light guide plate and a plurality of light sources. The light guide plate includes a light incident part and a flat panel. The light incident part and the flat panel have a common bottom surface. The maximum height of the wedge-shaped light incident part is greater than a height of the flat panel. The light incident part includes a light incident surface perpendicular to the bottom surface and a sloped surface sloping relative to the light incident surface. The flat panel includes a light emitting surface opposite to the bottom surface. The light incident part further includes a reflective layer on the sloped surface. The plurality of light sources is positioned adjacent to the light incident surface.

### BACKGROUND

1. Technical Field

The present disclosure relates to a liquid crystal display device, a backlight module used in the liquid crystal display device and a light guide plate used in the backlight module.

2. Description of Related Art

A backlight module can be used for illuminating a liquid crystal panel. The backlight module includes a light source and a light guide plate adjacent to the light source for an even distribution of light emitted from the light source. However, the light usage ratio of the light guide plate is typically low.

Therefore, it is desirable to provide a light guide plate, a backlight module and a liquid crystal display device which can overcome the limitations described.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, side view of a liquid crystal display device according to an exemplary embodiment of the present disclosure.

FIG. 2 is a top view of the liquid crystal display device of FIG. 1.

### DETAILED DESCRIPTION

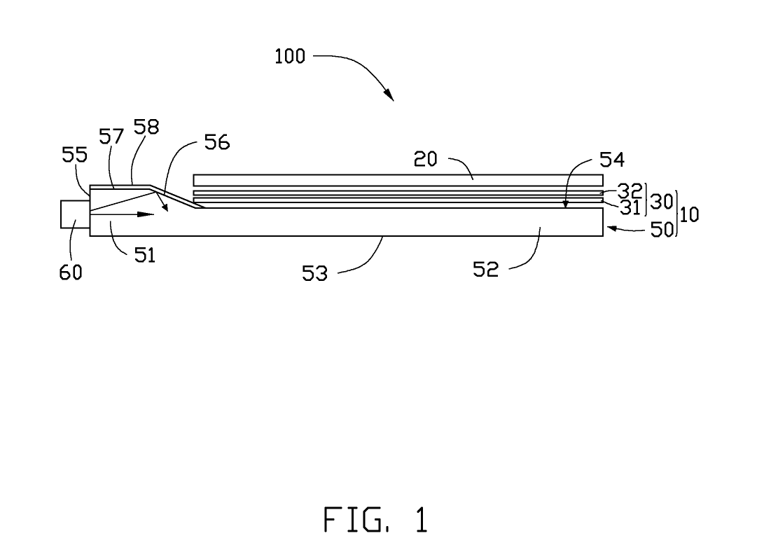

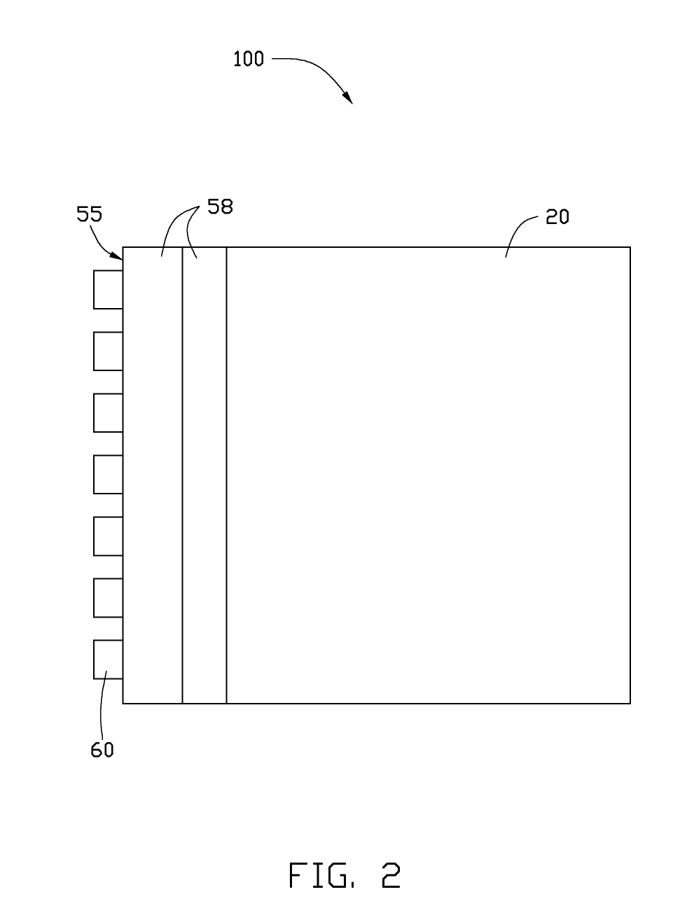

Referring to FIGS. 1 and 2, a liquid crystal display device 100 according to an exemplary embodiment is disclosed. The liquid crystal display device 100 includes a backlight module 10 and a liquid crystal display panel 20.

The backlight module 10 includes a light guide plate 50, a number of light sources 60 positioned adjacent to the light guide plate 50, and an optical film unit 30. In this embodiment, the light sources 60 are LEDs. The light guide plate 50 is made of plastic.

The light guide plate 50 includes a wedge-shaped light incident part 51 adjacent to the light sources 60 and a flat panel 52 connected to the light incident part 51 away from the light sources 60. The light incident part 51 and the panel 52 are integrally formed. The light incident part 51 and the panel 52 have a common bottom surface 53. The panel 52 includes a light emitting surface 54 opposite to the bottom surface 53. The light incident part 51 includes a light incident surface 55 adjacent to the light sources 60, a connecting surface 57 connecting to the light incident surface 55, and a sloped surface 56 connecting between the light emitting surface 54 and the connecting surface 57. The light incident surface 55 is substantially perpendicular to the bottom surface 53. The connecting surface 57 is parallel to the bottom surface 53. The sloped surface 56 slopes relative to the light incident surface 55. A reflective layer 58 is formed on the sloped surface 56 and the connecting surface 57. In this embodiment, the reflective layer 58 is made of reflective material, such as aluminum or nickel, and this material is coated on the sloped surface 56 and the connecting surface 57. In another embodiment, the reflective layer 58 can be formed on a flexible circuit board and adhered to the sloped surface 56 and the connecting surface 57.

The maximum height of the light incident part 51 (the distance between the bottom surface 53 and the connecting surface 57) is greater than the height of the panel 52 (the distance between the bottom surface 53 and the light emitting surface 54). In this embodiment, the maximum height of the light incident part 51 is about 0.7 millimeters (mm), the height of the panel 52 is about 0.5 mm.

The optical film unit 30 is positioned above the light emitting surface 54. The optical film unit 30 includes a diffuser film 31 and a brightness enhancement film 32, both made of resin. The liquid crystal display panel 20 is positioned above the optical film unit 30.

When in use, light emitted from the light sources 60 enters into the light guide plate 50 through the light incident surface 55, is emitted from the light emitting surface 54 and transmitted through the diffuser film 31 and the brightness enhancement film 32, and finally illuminates the liquid crystal display panel 20.

As the maximum height of the light incident part 51 is greater than that of the panel 52, more light can be introduced and concentrated into the light guide plate 50. As the reflective layer 58 is formed on the sloped surface 56 and the connecting surface 57, leakage of light from the sloped surface 56 and the connecting surface 57 is reduced and the greater concentration of light into the light guide plate 50 results in enhancement of the light usage ratio of the light guide plate 50. As the optical film unit 30 and the liquid crystal display panel 20 are only positioned above the panel 52, the total height of the liquid crystal display device 100 is reduced.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. A light guide plate comprising:
a light incident part; and
a flat panel; wherein
the light incident part and the flat panel have a common bottom surface, a maximum height of the light incident part is greater than a height of the flat panel, the light incident part comprises a light incident surface and a sloped surface, the light incident surface is perpendicular to the bottom surface, the sloped surface slopes relative to the light incident surface and connects to the flat panel, the flat panel comprises a light emitting surface opposite to the bottom surface, and the light incident part further comprises a reflective layer on the sloped surface.

2. The light guide plate of claim 1, wherein the light guide plate is made of plastic.

3. The light guide plate of claim 1, wherein the maximum height of the light incident part is about 0.7 millimeters, and the height of the flat panel is about 0.5 millimeters.

4. The light guide plate of claim 1, wherein the light incident part comprises a connecting surface connecting between the light incident surface and the sloped surface.

5. The light guide plate of claim 4, wherein the reflective layer is also positioned on the connecting surface.

6. A backlight module comprising:
a light guide plate comprising a light incident part and a flat panel, the light incident part and the flat panel having a common bottom surface, a maximum height of the light incident part being greater than a height of the flat panel, the light incident part comprising a light incident surface and a sloped surface, the light incident surface perpendicular to the bottom surface, the sloped surface sloping relative to the light incident surface and connecting to the flat panel, the flat panel comprising a light emitting surface opposite to the bottom surface, the light incident part further comprising a reflective layer on the sloped surface; and
a plurality of light sources positioned adjacent to the light incident surface.

7. The backlight module of claim 6, wherein the light guide plate is made of plastic.

8. The backlight module of claim 6, wherein the maximum height of the light incident part is about 0.7 millimeters, and the height of the flat panel is about 0.5 millimeters.

9. The backlight module of claim 6, wherein the light incident part further comprises a connecting surface connecting between the light incident surface and the sloped surface.

10. The backlight module of claim 9, wherein the reflective layer is also positioned on the connecting surface.

11. The backlight module of claim 6, further comprising an optical film unit above the light emitting surface.

12. The backlight module of claim 11, wherein the optical film unit comprises a diffuser film and a brightness enhancement film.

13. A liquid crystal display device, comprising:
a backlight module comprising:
a light guide plate comprising a light incident part and a flat panel, the light incident part and the flat panel having a common bottom surface, a maximum height of the light incident part being greater than a height of the flat panel, the light incident part comprising a light incident surface and a sloped surface, the light incident surface perpendicular to the bottom surface, the sloped surface sloping relative to the light incident surface and connecting to the flat panel, the flat panel comprising a light emitting surface opposite to the bottom surface, the light incident part further comprising a reflective layer on the sloped surface; and
a plurality of light sources positioned adjacent to the light incident surface; and
a liquid crystal display panel above the light emitting surface.

14. The liquid crystal display device of claim 13, wherein the light guide plate is made of plastic.

15. The liquid crystal display device of claim 13, wherein the maximum height of the light incident part is about 0.7 millimeters, and the height of the flat panel is about 0.5 millimeters.

16. The liquid crystal display device of claim 13, wherein the light incident part further comprises a connecting surface connecting between the light incident surface and the sloped surface.

17. The liquid crystal display device of claim 16, wherein the reflective layer is also positioned on the connecting surface.

18. The liquid crystal display device of claim 13, further comprising an optical film unit between the light emitting surface and the liquid crystal display panel.

19. The liquid crystal display device of claim 18, wherein the optical film unit comprises a diffuser film and a brightness enhancement film.
